(19) United States
(12) Patent Application Publication
(10) Pub. No.: US 2009/0080817 A1
(43) Pub. Date: Mar. 26, 2009

(54) FLUID DYNAMIC PRESSURE BEARING, SPINDLE MOTOR, DISK DRIVER, AND PRODUCTION METHOD OF THE FLUID DYNAMIC PRESSURE BEARING

(75) Inventor: Masato Gomyo, Kyoto (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 12/234,743

(22) Filed: Sep. 22, 2008

(30) Foreign Application Priority Data
Sep. 26, 2007 (JP) 2007-248723

(51) Int. Cl. F16C 32/06; H02K 5/00; B21D 53/10

(52) U.S. Cl. 384/121; 310/91; 29/898.02

(57) ABSTRACT

A thrust plate used in a fluid dynamic pressure bearing of the present invention includes a concave portion in which a lower end portion of a shaft is accommodated. The thrust plate is immersed in a lubricant, and is disposed between the lower end portion of the shaft and a bottom-portion upper surface of a bearing housing without being fixed to the bearing housing.

Accordingly, the thrust plate radially moves in accordance with the position in which the lower end portion of the shaft is in contact with the concave portion of the thrust plate. As a result, the centers of the shaft and the thrust plate motor can be aligned satisfactorily.

### BACKGROUND OF THE INVENTION

1. Field of the Invention

The present invention relates to a fluid dynamic pressure bearing, a spindle motor, a data storage driver, and a production method of the fluid dynamic pressure bearing.

2. Description of the Related Art

A data storage device used in a personal computer, an automobile navigation system, and the like includes a spindle motor which rotates data storage medium with the center axis thereof as the center of the rotation. The spindle motor has a configuration for relatively rotating a stationary unit and a rotor unit via a fluid dynamic pressure bearing. Recently, fluid dynamic pressure bearings are used in many cases.

A conventional fluid dynamic pressure bearing includes a radial bearing portion for radially supporting a shaft and a thrust bearing portion for axially supporting the shaft. The radial bearing portion has a sleeve through which the shaft is inserted. The shaft is supported by the fluid dynamic pressure of lubricantlubricant which is retained between the shaft and the sleeve. The thrust bearing portion has a disc-shaped thrust plate. The thrust bearing portion axially supports the shaft by causing a lower end portion of the shaft to come into contact with an upper surface of the thrust plate.

In some of such conventional fluid dynamic pressure bearings, a concave curved face is formed in a portion of or an entire of an upper surface of the thrust plate, and the shaft is supported on the concave curved face. Such a configuration increases the actual contact area between the lower end portion of the shaft and the upper surface of the thrust plate. Accordingly, the pressure from the shaft on the thrust plate is dispersed, and the abrasion of the thrust plate due to the abrasive contact of the shaft with the thrust plate is suppressed.

However, in the conventional fluid dynamic pressure bearing, a thrust plate such as a bearing housing, a sleeve, or the like is fixed. For this reason, it is difficult to align the centers of the shaft and the thrust plate satisfactorily.

If the center of the concave curved face is not accurately positioned on the center axis of the shaft, the abrasion occurs on the upper surface of the thrust plate because of the abrasive movement of the shaft and the thrust plate. This results in the deterioration in the rotational accuracy of the shaft or the rotational vibration.

### SUMMARY OF THE INVENTION

The fluid dynamic pressure bearing in one embodiment of the present invention includes a shaft, a sleeve, a lubricant retained between the shaft and the sleeve, a thrust plate, and a substantially cylindrical housing having a bottom. The shaft includes an end portion in which a convex curved face is formed. The sleeve supports the shaft in such a manner that the shaft can relatively rotate with the center axis of the shaft as the center.

In the interior of the housing, the sleeve and the thrust plate are placed.

The thrust plate has a concave portion with a concave curved face which is in contact with the end portion of the shaft.

The thrust plate is immersed in the lubricant, but is not fixed to the housing. The thrust plate is in contact with both of the end portion of the shaft and the inner bottom face of the housing, and is held therebetween in the axial direction. With such a configuration, the position of the thrust plate in the housing is determined.

According to one embodiment of the invention, the thrust plate moves in a direction substantially orthogonal to the center axis in accordance to the position in which the end portion of the shaft is in contact with the concave portion of the thrust plate, so that the centers of the shaft and the thrust plate are aligned satisfactorily. Thus, it is possible to prevent the abrasion of the thrust plate.

The curvature radius of the concave curved face of the thrust plate is equal to or larger than the curvature radius of the convex curved face of the shaft. Accordingly, it is possible to appropriately support the shaft in the concave portion of the thrust plate.

The fluid dynamic pressure bearing in another embodiment of the present invention includes a shaft, a sleeve, a lubricant retained between the shaft and the sleeve, a thrust plate, and a substantially cylindrical housing having a bottom. The shaft has an end portion in which a convex curved face is formed. The sleeve supports the shaft in such manner that the shaft can relatively rotate with the center axis of the shaft as the center.

The thrust plate has a plate convex portion of a curved shape which protrudes downwards from a lower surface of the thrust plate and which is in contact with an inner bottom face of the housing.

The thrust plate is immersed in the lubricant, but is not fixed to the housing. The thrust plate is held in the axial direction in such a condition that the thrust plate is in contact with both of the end portion of the shaft and the inner bottom face of the housing.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is a schematic sectional view of a data storage driver in a first preferred embodiment of the present invention taken along a plane including the center axis thereof.

FIG. 2 is a schematic sectional view of a spindle motor in the first preferred embodiment of the present invention taken along a plane including the center axis.

FIG. 3 is a schematic sectional view of a fluid dynamic pressure bearing in the first preferred embodiment of the present invention taken along a plane including the center axis.

FIG. 4 is a schematic sectional view showing a thrust plate and a configuration around the thrust plate in the first preferred embodiment of the present invention taken along a plane including an expanded center axis.

FIG. 5 is a schematic sectional view showing the thrust plate and a configuration around the thrust plate in the first preferred embodiment of the present invention taken along the plane including the expanded center axis.

FIG. 6 is a schematic horizontal sectional view showing the thrust plate and a bearing housing in the first preferred embodiment of the present invention.

FIG. 7 is a flowchart showing a production procedure of the spindle motor in the first preferred embodiment of the present invention.

FIG. 8 is a schematic sectional view showing a thrust plate and a configuration around the thrust plate in a second preferred embodiment of the present invention taken along a plane including a center axis.

FIG. 9 is a schematic sectional view showing the thrust plate and the configuration around the thrust plate in the second preferred embodiment of the present invention taken along the plane including the center axis.

FIG. 10 is a schematic sectional view showing a thrust plate and a configuration around the thrust plate in a modified embodiment taken along a plane including the center axis.

FIG. 11 is a schematic sectional view showing thrust plate and a configuration around the thrust plate in a modified embodiment taken along the plane including the center axis.

FIG. 12 is a schematic horizontal sectional view of a thrust plate and a bearing housing in a modified embodiment.

FIG. 13 is a schematic horizontal sectional view of a thrust plate and a bearing housing in a modified embodiment.

FIG. 14 is a schematic horizontal sectional view of a thrust plate and a bearing housing in a modified embodiment.

FIG. 15 is a schematic sectional view of a fluid dynamic pressure bearing in a modified embodiment taken along a plane including the center axis.

### DETAILED DESCRIPTION OF PREFERRED EMBODIMENTS

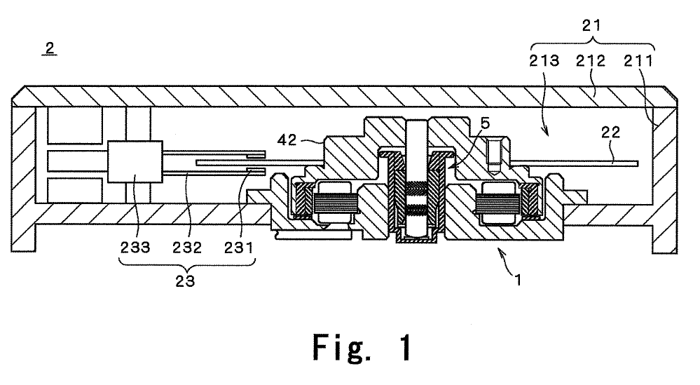

Hereafter, with reference to FIGS. 1 through 15, preferred embodiments of the present invention will be described. It should be noted that in the description of the present invention, for the convenience of description, the terms “upper”, “lower”, “an upper face”, “a lower face”, and the like are used depending on orientations on the upper and lower sides in FIGS. 1 to 5, 8 to 11, and 15. However, the terms do not limit the installation orientations of a fluid dynamic pressure bearing, a spindle motor, and a data storage driver of the present invention.

FIG. 1 is a schematic sectional view of a data storage driver 2 according to a first preferred embodiment of the present invention. The data storage driver 2 is a hard disk driver which reads and writes information while a magnetic data storage medium 22 is rotated. As shown in FIG. 1, the data storage driver 2 preferably includes a device housing 21, the data storage medium 22, an access portion 23, and a spindle motor 1.

The device housing 21 preferably includes a cup-shaped first housing member 211, and a plate-shaped second housing member 212. The first housing member 211 preferably has an opening in an upper portion thereof. On an inner bottom face of the first housing member 211, the spindle motor 1 and the access portion 23 are placed.

The second housing member 212 is preferably joined to the first housing member 211 so as to cover the opening of the upper portion of the first housing member 211. The data storage medium 22, the spindle motor 1, and the access portion 23 are preferably accommodated in an inner space 213 of the device housing 21 enclosed by the first housing member 211 and the second housing member 212. The inner space 213 of the device housing 21 is preferably a clean space.

The data storage medium 22 is preferably a substantially disc-shaped preferably having a hole in a center portion thereof. The data storage medium 22 is preferably mounted on a hub member 42 of the spindle motor 1 and rotatably supported on the spindle motor 1. On the other hand, the access portion 23 preferably includes a head 231, an arm 232, and a head moving mechanism 233. The head 231 accesses to a principal surface of the data storage medium 22, thereby magnetically performing the reading and the writing of information from and to the data storage medium 22. The arm 232 preferably supports the head 231 and swings along the principal surface of the data storage medium 22. The head moving mechanism 233 is preferably disposed at the side of the data storage medium 22. The head moving mechanism 233 relatively moves the head 231 with respect to the data storage medium 22 by swinging the arm 232. Accordingly, the head 231 accesses to a required position of the data storage medium 22 which is rotated, whereby the reading and the writing of information is performed from and to the data storage medium 22. The head 231 may perform either one of the reading or the writing of information with respect to the data storage medium 22.

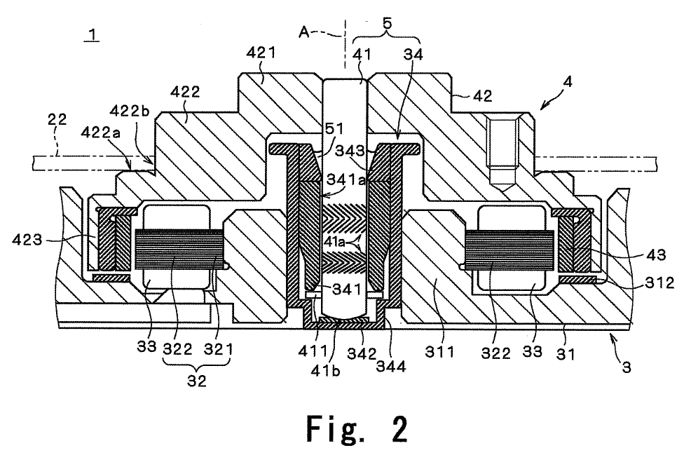

Next, the configuration of the spindle motor 1 will be described. FIG. 2 is a sectional view of the spindle motor 1 taken along a plane including the center axis thereof. As shown in FIG. 2, the spindle motor 1 preferably includes a stationary unit 3 fixed to the device housing 21 of the data storage driver 2, and a rotor unit 4 on which the data storage medium 22 is mounted and which rotates around a predetermined center axis A.

The stationary unit 3 preferably includes a base member 31, a stator core 32, a coil 33, and a bearing unit 34.

The base member 31 is preferably made from a metal material such as aluminum, and fixed to the device housing 21 of the data storage driver 2 by screws or the like. In the base member 31, a substantially cylindrical holder portion 311 protruding in an axial direction (i.e., in a direction along the center axis A) is formed around the center axis A.

An inner circumferential surface (i.e. a circumferential surface on the inner side with respect to the center axis A) of the holder portion 311 preferably constitutes a through hole for holding the bearing unit 34. An outer circumferential surface (i.e. a circumferential surface on the outer side with respect to the center axis A) of the holder portion 311 preferably constitutes an attachment face for fitting the stator core 32.

In the present preferred embodiment, the base member 31 and the first housing member 211 are separate from one another. Alternatively, the base member 31 and the first housing member 211 may be formed as a single member. In such a case, the holder portion 311 is preferably formed in the member constituting the base member 31 and the first housing 211.

The stator core 32 preferably includes a core back 321 fitted to the outer circumferential surface of the holder portion 311, and a plurality of tooth portions 322 protruding outwards in a radial direction (i.e., a radial direction with respect to the center axis A) from the core back 321. The stator core 32 is preferably formed, for example, by using laminated steel sheets in which electro-magnetic steel sheets are laminated in the axial direction.

The coil 33 is preferably constituted by a conductive wire which is wound around each of the tooth portions 322 of the stator core 32. The coil 33 is preferably connected to a predetermined power supply (not shown). When a driving current is supplied from the power supply to the coil 33, a magnetic flux is radially generated in the tooth portions 322. The mutual reaction between the magnetic flux generated in the tooth portions and a magnetic flux of the rotor magnet 43 which will be described later generates a torque for rotating the rotor unit 4 around the center axis A.

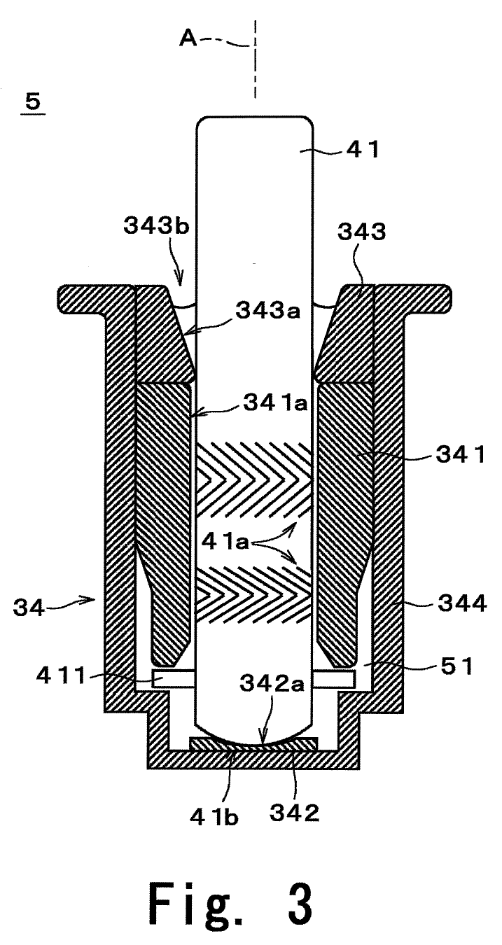

The bearing unit 34 preferably supports the shaft 41 on the side of the rotor unit 4 in a relatively rotatable manner. The bearing unit 34 preferably constitutes a fluid dynamic pressure bearing 4 together with the shaft 41. FIG. 3 is a sectional view showing the configuration of the fluid dynamic pressure bearing 5 taken along the plane including an expanded center axis. As shown in FIG. 3, the bearing unit 34 preferably includes a sleeve 341, a thrust plate 342, a seal member 343, and a bearing housing 344.

The sleeve 341 is a substantially cylindrical member preferably having a bearing hole 341a into which the shaft 41 is inserted. The sleeve 341 is preferably fixed to an inner circumferential surface of the bearing housing 344. In a gap between an inner circumferential surface of the sleeve 341 and an outer circumferential surface of the shaft 41, a radial dynamic pressure bearing portion for generating a fluid dynamic pressure in lubricant retained in the gap is formed when the motor 1 revolves.

A gap between the inner circumferential surface of the sleeve 341 and the outer circumferential surface of the shaft 41 is preferably filled with a lubricant 51 which will be described later. The sleeve 341 is preferably formed by a sintered body obtained by heating metal powders so as to couple and harden the metal powders. For this reason, the sleeve 341 is microscopically a porous body with a number of minute air holes. Thus, the surface of the sleeve 341 is preferably impregnated with the lubricant. The shaft 41 preferably slides satisfactorily with respect to the sleeve 341 which is impregnated with the lubricant. The sleeve 341 which is formed by the sintered body can be obtained at a relatively low cost.

The thrust plate 342 is a substantially disc-shaped member positioned on the lower side of the shaft 41. An upper surface of the thrust plate 342 is preferably in contact with a lower end portion 41b of the shaft 41, so as to axially support the shaft 41, and to allow the shaft 41 to rotate around the center axis A. The lower end portion 41b of the shaft 41 and the thrust plate 342 preferably constitute a thrust bearing portion. The thrust plate 342 can be constituted by using a thermal plastic resin such as polyacetal or nylon as its material.

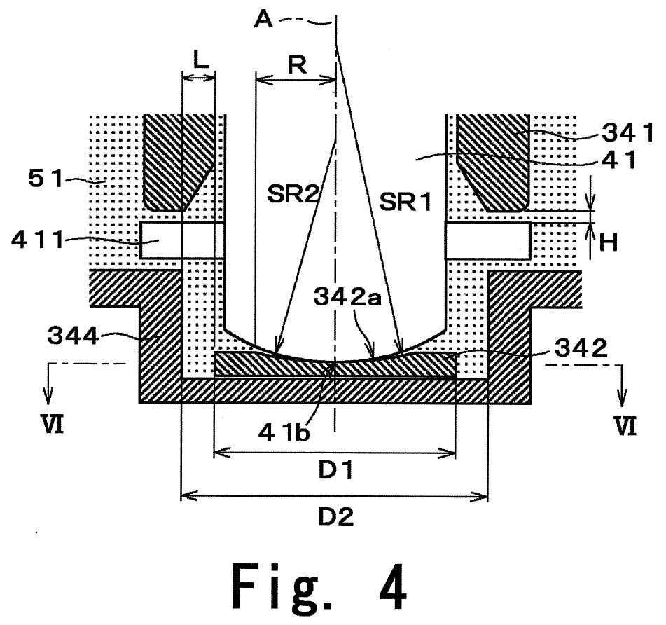

FIG. 4 is a sectional view showing the thrust plate 342 and the configuration around the thrust plate 342 taken along a plane including the center axis which is shown in a further expanded manner. As shown in FIG. 4, a concave portion 342a having a concave curved face (a partially spherical surface) is preferably formed in the center portion of the upper surface of the thrust plate 342. The curvature radius SR1 of the concave portion 342a is substantially equal to or larger than the curvature radius SR2 of the lower end portion 41b of the shaft 41. Accordingly, the upper surface of the concave portion 342a is preferably in contact with the lower end portion 41b of the shaft 41 in a plane or in a point. A so-called pivot bearing portion is preferably constituted between the thrust plate 342 and the shaft 41.

The shaft 41 can rotate around the center axis A with a minute rotative resistance in the pivot bearing portion. The concave portion 342a formed on the upper surface of the thrust plate 342 preferably increases the actual contact area of the thrust plate 342 with the shaft 41, so that the pressure from the shaft 41 on the thrust plate 342 is dispersed. Accordingly, the abrasion of the upper surface of the thrust plate 342 can be suppressed.

As shown in FIG. 4, the thrust plate 342 is preferably disposed between a bottom-portion upper surface of the bearing housing 344 and the lower end portion 41b of the shaft 41 in the interior of the bearing housing 344. The thrust plate 342 is not fixed to the bearing housing 344. The thrust plate 342 is held between the bottom-portion upper surface of the bearing housing 344 and the lower end portion 41b of the shaft 41, so that the thrust plate 342 moves to the most stable position, thereby determining the position thereof.

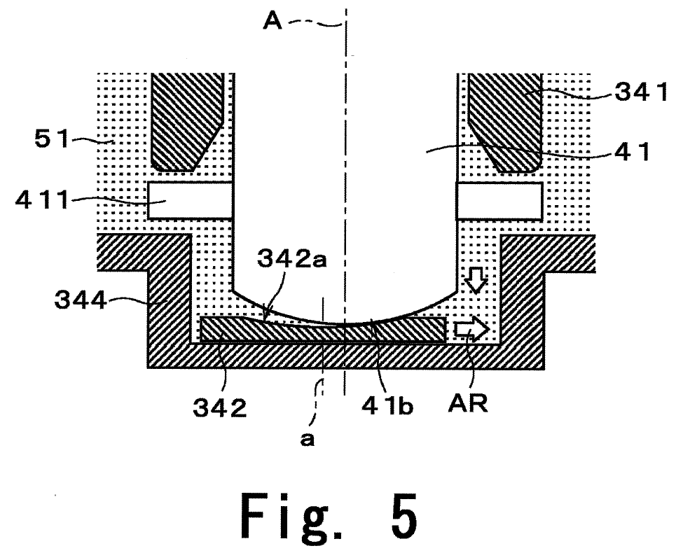

The mechanism for positioning the thrust plate 342 in the interior of the bearing housing 344 will be described in more detail with reference to FIG. 5.

As shown in FIG. 5, in the case where the thrust plate 342 is displaced in the interior of the bearing housing 344, the lower end portion 41b of the shaft 41 is preferably in contact with an inclined face which is out of a center axis a of the concave portion 342a of the thrust plate 342. In such a case, a drag is mutually applied to the lower end portion 41b of the shaft 41 and the concave portion 342a of the thrust plate 342. Due to a component force of the drag, the thrust plate 342 moves in the radial direction as indicated by arrow AR.

As a result, the lower end portion 41b of the shaft 41 becomes into contact with the deepest position of the concave portion 342a of the thrust plate 342 as shown in FIG. 4. At this time, the center axis A of the concave portion 342a of the thrust plate 342 substantially agrees with the center axis A of the shaft 41. That is, the centers of the shaft 41 and the thrust plate 342 are aligned.

The center alignment of the shaft 41 and the thrust plate 342 is appropriately performed in a production process of the spindle motor 1 which will be described later. In the spindle motor 1 after the production, if the position of the thrust plate 342 in the bearing housing 344 is displaced by any external impact, the above-described center alignment is performed.

Specifically, in the fluid dynamic pressure bearing 5 in the present preferred embodiment, even when the position of the thrust plate 342 is shifted in the interior of the bearing housing 344, the thrust plate 342 moves in accordance with the position in which the shaft 41 is in contact with the thrust plate 342, so that the center aligned condition of the shaft 41 and the thrust plate 342 is automatically restored. Thus, the abrasion of the concave portion 342a of the thrust plate 342 can be prevented, and the deterioration in rotational accuracy and the occurrence of the rotational vibration can be prevented.

As shown in FIG. 4, it is preferred that the radial dimension D1 of the thrust plate 342 is larger than the half of an inner diameter D2 of the bearing housing 344. Accordingly, even when the position of the thrust plate 342 is shifted in the interior of the bearing housing 344, the entire of the thrust plate 342 is hardly deviated from the center axis A. Thus, it is possible to prevent the thrust plate 342 from being withdrawn from the portion between the bottom-portion upper surface of the bearing housing 344 and the lower end portion 41b of the shaft 41.

As shown in FIG. 4, it is preferred that the radius R of the concave portion 342a of the thrust plate 342 is larger than a radial distance L between the outer circumferential surface of the thrust plate 342 and the inner circumferential surface of the bearing housing 344. The radius R indicates the radial distance from the center axis A to the outer periphery of the concave portion 342a.

Accordingly, even in the case where the position of the thrust plate 342 is shifted in the interior of the bearing housing 344, the entire of the concave portion 342a is not deviated from the center axis A. Therefore, the lower end portion 41b of the shaft 41 makes no contact with a face other than the concave portion 342a of the thrust plate 342, so that the center alignment of the shaft 41 and the thrust plate 342 can always effectively function.

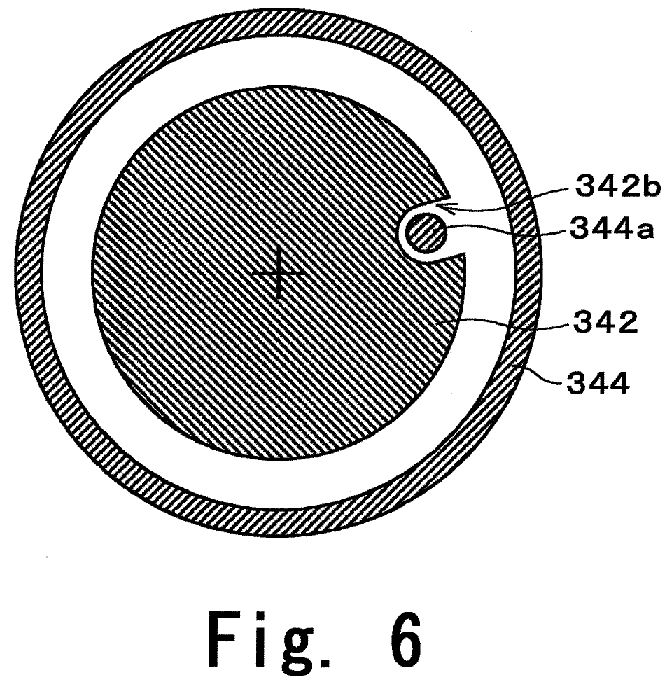

FIG. 6 is a horizontal sectional view of the thrust plate 342 and the bearing housing 344 taken along the plane VI-VI in FIG. 4. As shown in FIG. 6, on the bottom-portion upper surface of the bearing housing 344, a protruding portion 344a protruding upwards is formed. In a peripheral portion of the thrust plate 342, a notch portion 342b which is preferably engaged with the protruding portion 344a is formed.

With this configuration, when the thrust plate 342 is to rotate around the center axis A, the protruding portion 344a and the notch portion 342b mutually come into contact in the circumferential direction, so as to prevent the rotation of the thrust plate 342.

The protruding portion 344a and the notch portion 342b preferably function as “a rotation stopper” for preventing the rotation of the thrust plate 342 around the center axis A. Thus, the protruding portion 344a and the notch portion 342b prevent the rotation of the thrust plate 342 with the shaft 41.

In order not to prevent the radial movement of the thrust plate 342, a gap is preferably formed between the protruding portion 344a and the notch portion 342b. The dimension of the gap formed between the protruding portion 344a and the notch portion 342b is preferably smaller than the radius R of the concave portion 342a formed on the thrust plate 342. With such a configuration, even if the position of the thrust plate 342 is shifted, the entire of the concave portion 342a is not deviated from the center axis A.

Referring back to FIG. 3, the seal member 343 is preferably a substantially annular member disposed in the upper portion of the sleeve 341. An inner circumferential surface 343a of the seal member 343 is preferably an inclined face in which the inner diameter is increased toward the upper side. Accordingly, the width of a gap 343b between the inner circumferential surface 343a of the seal member 343 and the outer circumferential surface of the shaft 41 is preferably increased toward the upper side. The vapor-liquid interface of the lubricant 51 formed in the gap 343b is meniscus due to the surface tension. With this configuration, it is possible to prevent the lubricant 51 from leaking out of the bearing unit 34. That is, a taper seal portion is formed in the gap 343b between the seal member 343 and the shaft 41. The seal member 343 is preferably formed from a metal such as stainless or aluminum or a resin. Alternatively, the seal member 343 and the sleeve 341 may be formed as a single member.

The bearing housing 344 is preferably a substantially cylindrical member having a bottom for accommodating the sleeve 341, the thrust plate 342, and the seal member 343 on the inside thereof. The bearing housing 344 is preferably fixed in the interior of the through hole formed on the inner circumferential side of the holder portion 311 of the base member 31 by means of press fitting, or shrinkage fitting.

The sleeve 341 and seal member 343 are preferably fixed to the inner circumferential surface of the bearing housing 344. The thrust plate 342 is preferably disposed on the bottom face of the bearing housing 344. The bearing housing 344 is, for example, obtained by press working of a zinc-plated steel sheet (SECE) in which zinc plating is performed on the surface of a cold rolling steel sheet (SPCC, SPCD, SPCE), so as to have a cylindrical shape having a bottom. The bearing housing 344 may be configured from one steel sheet. Alternatively, the bearing housing 344 may be configured by combining a plurality of different members. For example, the bottom portion and the cylindrical portion of the bearing housing 344 may be formed as separate members, respectively.

The interior of the bearing housing 344 is preferably filled with the lubricant 51 including ester as the principal component. As the lubricant 51, for example, an oil including ester as the principal component, such as polyol ester oil, or diester oil may be used. Such an oil including ester as the principal component has superior properties of abrasion resistance, heat stability, and flowability, so that the oil is suitable for the lubricant 51 of the fluid dynamic pressure bearing 5. In addition to the gap between the sleeve 341 and the shaft 41, a gap between the shaft 41 and the thrust plate 342 and a gap between the thrust plate 342 and the bearing housing 344 are continuously filled with the lubricant 51.

The thrust plate 342 is preferably immersed in the lubricant 51 with which the interior of the bearing housing 344 is filled. Thus, the thrust plate 342 smoothly slides with respect to the lower end portion 41b of the shaft 41 and the bottom-portion upper surface of the bearing housing 344. When the lower end portion 41b of the shaft 41 comes into contact with the upper surface of the concave portion 342a of the thrust plate 342, the thrust plate 342 smoothly moves in the radial direction in accordance with the contact position. Thus, the centers of the shaft 41 and the thrust plate 342 are aligned satisfactorily.

In the condition where the thrust plate 342 is immersed in the lubricant 51, when the thrust plate 342 is held between the lower end portion 41b of the shaft 41 and the bottom-portion upper surface of the bearing housing 344, the peripheral portion of the thrust plate 342 is slightly lifted due to the buoyancy from the lubricant. The thrust plate 342 is slightly curved so as to surround the lower end portion 41b of the shaft 41, so that the center aligned condition of the shaft 41 and the thrust plate 342 is stably maintained.

Referring back to FIG. 2, the rotor unit 4 includes the shaft 41, a hub member 42, and a rotor magnet 43.

The shaft 41 is preferably a substantially columnar member disposed along the center ax is A. The shaft 41 is preferably supported by the bearing unit 34 in such a condition that the lower portion of the shaft 41 is inserted in a bearing hole 341a of the sleeve 341, thereby rotating around the center axis A. On the outer circumferential surface of the shaft 41, herringbone radial dynamic pressure groove strings 41a for generating a fluid dynamic pressure in the lubricant 51 interposed between the outer circumferential surface of the shaft 41 and the inner circumferential surface of the sleeve 341 are disposed.

When the shaft 41 spins, the lubricant 51 is pressurized by means of the radial dynamic pressure groove strings 41a. The lubricant 51 functions as working fluid, so that the shaft 41 is radially supported and rotated. The radial dynamic pressure groove strings 41a may be formed on either one of the outer circumferential surface of the shaft 41 or the inner circumferential surface of the sleeve 341.

In the vicinity of the lower end portion of the shaft 41, a flange member 411 is preferably fixed to the shaft 41. The flange member 411 prevents the shaft 41 from being dropped out of the bearing unit 34. The flange member 411 preferably protrudes radially from the outer circumferential surface of the shaft 41. The upper surface of the flange member 411 is axially opposed to the lower face of the sleeve 341. When a force toward the upper side acts on the rotor unit 4, the upper surface of the flange member 411 comes into contact with the lower face of the sleeve 341, so that it becomes possible to prevent the stationary unit 3 and the rotor unit 4 from being separated. The shaft 41 and the flange member 411 may be formed as a single member.

The lower end portion 41b of the shaft 41 has a convex curved face (a partially spherical shape), and protrudes downwards on the lower side than the flange member 411. The lower end portion 41b of the shaft 41 is in contact with the concave portion 342a of the thrust plate 342 (see FIG. 3), so that the shaft 41 is axially supported.

An axial interval H between the upper surface of the flange member 411 and the lower face of the sleeve 341 (see FIG. 4) is preferably smaller than the depth of the concave portion 342a formed on the upper surface of the thrust plate 342. With such a configuration, the upper displacement amount of the shaft 41 is limited to be D or less, so that it is possible to prevent the lower end portion 41b of the shaft 41 from being withdrawn from the thrust plate 342.

The hub member 42 is preferably a member fixed to the shaft 41, thereby rotating together with the shaft 41. The hub member 42 preferably includes a portion expanded outwards in the radial direction around the center axis A. In more detail, the hub member 42 preferably includes a joining portion 421, a barrel portion 422, and a hanging portion 423. The joining portion 421 is preferably joined to the upper end portion of the shaft 41 by means of press fitting, shrinkage fitting, or the like. The barrel portion 422 preferably expands radially outwards and downwards from the joining portion 421. The hanging portion 423 is hung from the outer periphery of the barrel portion 422. The hub member 42 covers the upper side of the stator core 32, the coil 33, and the bearing unit 34.

In the barrel portion 422 of the hub member 42, a first supporting face 422a and a second supporting face 422b for supporting the data storage medium 22 are formed. The first supporting face 422a is preferably a plane formed vertically with respect to the center axis A. The second supporting face 422b is preferably a cylindrical face formed in parallel to the center axis A on the inner circumferential side of the first supporting face 422a. When the data storage medium 22 is mounted on the hub member 42, a lower surface of the data storage medium 22 comes into contact with the first supporting face 422a, and an inner circumferential portion (an inner circumferential surface or an inner periphery) of the data storage medium 22 comes into contact with the second supporting face 422b. With this configuration, the data storage medium 22 is supported in a horizontal condition. The hub member 42 may be formed from a metal material such as aluminum, ferromagnetic stainless steel, cold rolled steel sheet (SPCC, SPCD, SPCE), or the like.

The rotor magnet 43 is preferably fixed on the inner circumferential surface of the hanging portion 423 of the hub member 42. The rotor magnet 43 is preferably annularly disposed so as to enclose the center axis A. The inner circumferential surface of the rotor magnet 43 is preferably a magnetic pole face, and is opposed to the outer circumferential surfaces of the plurality of tooth portions 322 of the stator core 32.

The rotor magnet 43 is preferably disposed in such a manner that the height of the magnetic center is slightly higher than the height of the magnetic center of the tooth portion 322. Specifically, the rotor magnet 43 and the tooth portion 322 are provided with magnetic bias with respect to the axial direction. Accordingly, an axial suction component is generated preferably between the tooth portions 322 and the rotor magnet 43. Thus, forces in mutually approaching directions act between the rotor unit 4 and the stationary unit 3. As a result, forces in mutually approaching directions act between the lower end portion 41b of the shaft 41 and the concave portion 342a of the thrust plate 342, so that the center alignment of the shaft 41 and the thrust plate 342 effectively functions.

In a position of the upper surface of the base member 31 axially opposed to the rotor magnet 43, a thrust yoke 312 formed by a magnetic material such as stainless is fixed. Accordingly, a magnetic suction is caused preferably between the thrust yoke 312 and the rotor magnet 43. The suction increases the force which acts between the rotor unit 4 and the stationary unit 3. Alternatively, without the provision of the thrust yoke 312, the axial suction may be generated only by the positional relationship between the rotor magnet 43 and the tooth portions 322. Alternatively, without forming the magnetic bias between the rotor magnet 43 and the tooth portions 322, the axial suction may be generated only by the action of the thrust yoke 312.

In the spindle motor 1 having the above-described configuration, when a driving current is applied to the coil 33 of the stationary unit 3, a radial magnetic flux is generated in the plurality of tooth portions 322 of the stator core 32. Due to the magnetic flux between the tooth portions 322 and the rotor magnet 43, a torque is generated, so that the rotor unit 4 is rotated around the center axis A with respect to the stationary unit 3. The data storage medium 22 supported on the hub member 42 is rotated around the center axis A together with the shaft 41 and the hub member 42.

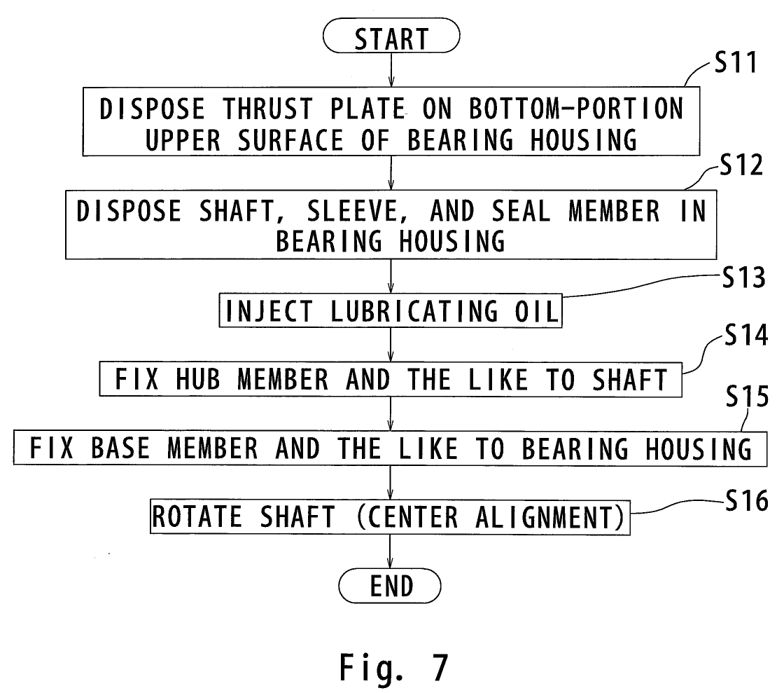

Next, the production procedure of the above-described spindle motor 1 will be described with reference to the flowchart shown in FIG. 7.

When a spindle motor 1 is to be produced, the shaft 41, the sleeve 341, the thrust plate 342, the seal member 343, and the bearing housing 344 are prepared first. Then, the thrust plate 342 is inserted into the interior of the bearing housing 344, and the thrust plate 342 is placed on the bottom-portion upper surface of the bearing housing 344 (Step S1).

Next, the shaft 41, the sleeve 341, and the seal member 343 are placed in the predetermined positions in the interior of the bearing housing 344, respectively (Step S2). In the interior of the bearing housing 344, the outer circumferential surface of the shaft 41 is opposed to the inner circumferential surface of the sleeve 341, and the lower end portion 41b of the shaft 41 is opposed to the concave portion 342a formed on the upper surface of the thrust plate 342.

Next, the lubricant 41 is injected through the gap between the shaft 41 and the seal member 343, so that the interior of the bearing housing 344 is filled with the lubricant 51 (Step S3). With the lubricant 51 injected into the interior of the bearing housing 344, the gap between the lower end portion 41b of the shaft 41 and the concave portion 342a of the thrust plate 342, and the gap between the lower face of the thrust plate 342 and the bottom-portion upper surface of the bearing housing 344 are continuously filled. Thus, the slidability between the lower end portion 41b of the shaft 41 and the concave portion 342a of the thrust plate 342 and the slidability between the lower surface of the thrust plate 342 and the bottom-portion upper surface of the bearing housing 344 are improved. Additionally, the thrust plate 342 can move satisfactorily in the radial direction between the shaft 41 and the bearing housing 344.

Next, the hub member 42 is preferably fixed to the shaft 41 (Step S4). The rotor magnet 43 is previously fixed to the hub member 42. Accordingly, when the hub member 42 is fixed to the shaft 41, the shaft 41, the hub member 42, and the rotor magnet 43 preferably constitute the rotor unit 4.

Next, the integrated rotor unit 4 and the bearing unit 34 are joined to the base member 31. In this step, the base member 31 is preferably fixed to the bearing housing 344 of the bearing unit 34 (Step S5).

The stator core 32 and the coil 33 are previously fixed to the base member 31. Accordingly, when the base member 31 is fixed to the bearing housing 344, the base member 31, the stator core 32, the coil 33, and the bearing unit 34 preferably constitute the stationary unit 3.

Thereafter, a driving current is preferably applied to the coil 33, so that the rotor unit 4 rotates at a predetermined rotational speed with respect to the stationary unit 3. The shaft 41 rotates around the center axis A in the condition where the lower end portion 41b thereof is in contact with the concave portion 342a of the thrust plate 342 (Step S6). At this time, the thrust plate 342 radially moves due to the force from the shaft 41. Accordingly, the center axis A of the concave portion 342a of the thrust plate 342 substantially agrees with the center axis A of the shaft 41. That is, the centers of the shaft 41 and the thrust plate 342 are aligned.

As described above, the thrust plate 342 used in the fluid dynamic pressure bearing 5 in the present preferred embodiment preferably includes the concave portion 342a for accommodating the lower end portion 41a of the shaft 41. In addition, the thrust plate 342 is preferably immersed in the lubricant 51, and is held between the lower end portion 41b of the shaft 41 and the bottom-portion upper surface of the bearing housing 344 without being fixed to the bearing housing 344. Accordingly, the thrust plate 342 radially moves in accordance with the position where the lower end portion 41b of the shaft 41 is in contact with the concave portion 342a of the thrust plate 342. As a result, the centers of the shaft 41 and the thrust plate 342 are aligned satisfactorily. Therefore, the abrasion of the thrust plate 342 can be minimized.

Next, a second preferred embodiment of the present invention will be described. The second preferred embodiment utilizes a thrust plate 345 having a different shape from that of the thrust plate 342 in the first preferred embodiment. Other than the thrust plate 345, the configurations of the data storage driver 2, the spindle motor 1, and the fluid dynamic pressure bearing 5 are the same as those in the first preferred embodiment, so that the descriptions thereof are omitted. Therefore, in the following description, the thrust plate 345 and the configurations around the thrust plate 345 are mainly described.

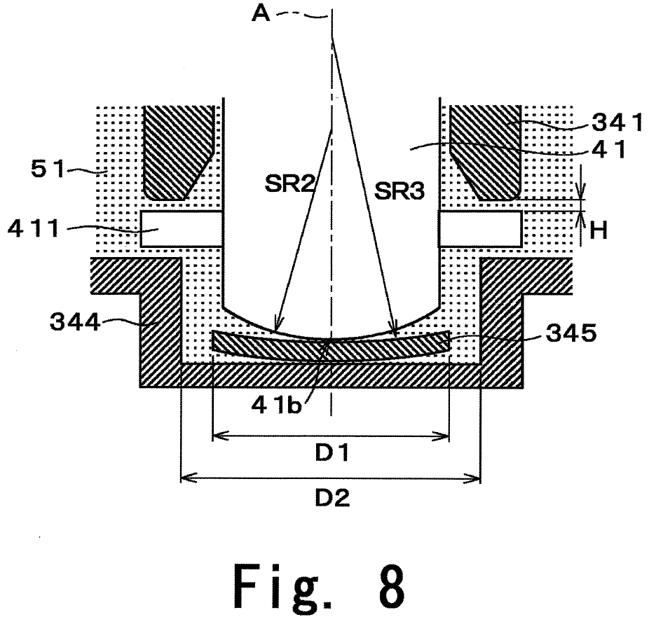

FIG. 8 is a sectional view of the thrust plate 345 and the configuration around the thrust plate 345 in the second preferred embodiment taken along a plane including the center axis thereof. As shown in FIG. 8, the thrust plate 345 preferably has an upper surface which is a concave curved face, and a lower surface which is a convex curved face. As a whole, the thrust plate 345 preferably has a curved shape which protrudes toward the bottom portion of the bearing housing 344.

It is preferred that the curvature radius SR3 of the upper surface of the thrust plate 345 is substantially equal to or larger than the curvature radius of the lower end portion 41b of the shaft 41. Accordingly, the upper surface of the thrust plate 345 is in contact with the lower end portion 41b of the shaft 41 in a plane or in a point. Between the thrust plate 345 and the shaft 41, a so-called pivot bearing portion is configured.

In such a pivot bearing portion, the shaft 41 can rotate around the center axis A with a minute rotational resistance. Because the thrust plate 345 has the curved shape, the actual contact area between the thrust plate 345 and the shaft 41 is increased, so that the pressure from the shaft 41 on the thrust plate 345 is dispersed. With such a configuration, the abrasion of the upper surface of the thrust plate 345 is minimized.

As shown in FIG. 8, the thrust plate 345 is preferably disposed between the bottom face of the bearing housing 344 and the lower end portion 41b of the shaft 41, in the interior of the bearing housing 344. The thrust plate 345 is not fixed to the bearing housing 344. The thrust plate 345 is preferably held between the bottom face of the bearing housing 344 and the lower end portion 41b of the shaft 41, so that the position and the orientation thereof are stably determined.

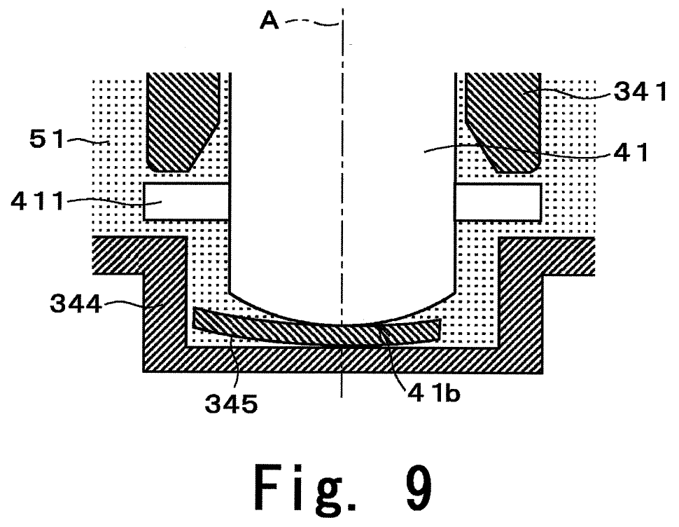

FIG. 9 is a sectional view of the thrust plate 345 and the configuration around the thrust plate 345 taken along the plane along the center axis in the case where the position of the thrust plate 345 is slightly displaced in the interior of the bearing housing 344.

As shown in FIG. 9, when the position of the thrust plate 345 is displaced, the lower end portion 41b of the shaft 41 is in contact with the portion which is deviated from the center of the upper surface of the thrust plate 345. The thrust plate 345 receives downward pressure in the portion where thrust plate 345 is in contact with the shaft 41. Thus, the thrust plate 345 is preferably inclined so that the portion in contact with the shaft 41 is the lowest. In such a condition, the position and orientation of the thrust plate 345 are stable, so that the thrust plate 345 supports the shaft 41 in the portion of the thrust plate 345 which is in contact with the shaft 41 on the center axis A.

Specifically, since the thrust plate 345 in the present preferred embodiment has the curved shape, if the shaft 41 is in contact with any portion of the upper surface of the thrust plate 345, the shaft 41 can be supported with the contact portion as the center.

Accordingly, the centers of the shaft 41 and the thrust plate 345 can be aligned satisfactorily. The thrust plate 345 in the present preferred embodiment is not fixed to the bearing housing 344, so that the thrust plate 345 can radially move in the interior of the bearing housing 344.

Accordingly, when the shaft 41 comes into contact with the upper surface of the thrust plate 345, the thrust plate 345 slightly moves in the radial direction due to the radial component force of the effect generated between the thrust plate 345 and the shaft 41. However, such movement is not really a problem.

The center alignment between the shaft 41 and the thrust plate 345 is appropriately performed in the production process of 29 the spindle motor 1. In the spindle motor 1 after the production, if the position of the thrust plate 345 is displaced in the interior of the bearing housing 344, the thrust plate 345 is inclined in accordance with the portion in contact with the shaft 41 in such a displaced condition. Accordingly, the thrust plate 345 can support the shaft 41 with the portion in contact with the shaft 41 as the center. That is, in the fluid dynamic pressure bearing 5 in the present preferred embodiment, the thrust plate 345 can be inclined, so that the center aligned condition between the shaft 41 and the thrust plate 345 can always be maintained. Accordingly, the abrasion of the upper surface of the thrust plate 345 can be minimized, and the deterioration of the rotational accuracy, and the occurrence of the rotational vibration can be minimized.

As shown in FIG. 8, the radial dimension D1 of the thrust plate 345 is preferably larger than the half of the inner diameter D2 of the bearing housing 344. Accordingly, in the interior of the bearing housing 344, even if the position of the thrust plate 345 is displaced, the entire of the thrust plate 345 is not deviated from the center axis A.

As described above, the thrust plate 345 is not departed from the portion between the bottom-portion upper surface of the bearing housing 344 and the lower end portion 41b of the shaft 41. The depth of the concave curved face formed on the upper surface of the thrust plate 345 is preferably larger than the axial interval H between the upper surface of the flange member 411 and the lower surface of the sleeve 341. With such a configuration, the departure of the thrust plate 345 from the portion between the lower end portion 41b of the shaft 41 and the bottom-portion upper surface of the bearing housing 344 can be further prevented.

Similarly to the thrust plate 342 in the first preferred embodiment, a notch portion is preferably formed in the thrust plate 345 in the second preferred embodiment. The notch portion is preferably engaged with a protruding portion 344a formed on the bottom surface of the bearing housing 344, thereby functioning as a rotation stopper.

The production procedure of the spindle motor 1 of the second preferred embodiment is substantially similar to the production procedure of the spindle motor 1 of the first preferred embodiment. In other words, the spindle motor 1 is produced in accordance with the procedure shown in the flowchart of FIG. 7. However, in Step S6, the shaft 41 is rotated in the condition where the lower end portion 41b of the shaft 41 is in contact with the upper surface of the thrust plate 345, and the thrust plate 345 is inclined due to the force from the shaft 41. Thus, the center alignment of the shaft 41 and the thrust plate 345 is performed.

The preferred embodiments of the present invention are described above, but the present invention is not limited to those above-described preferred embodiments. For example, the shape of the thrust plate may be variously changed, in addition to the shapes shown in the first and second preferred embodiments.

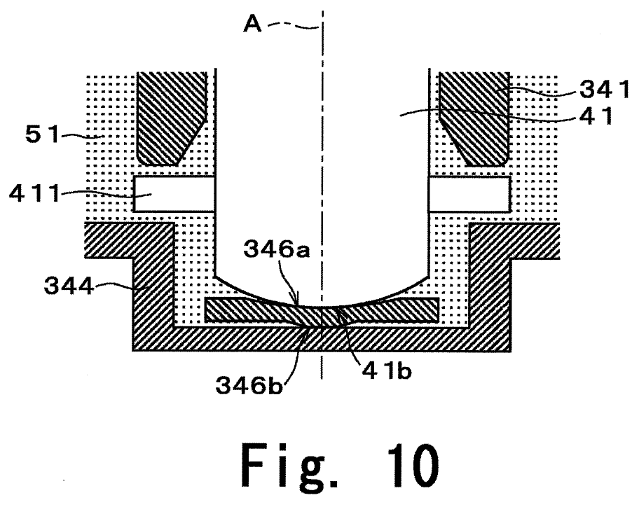

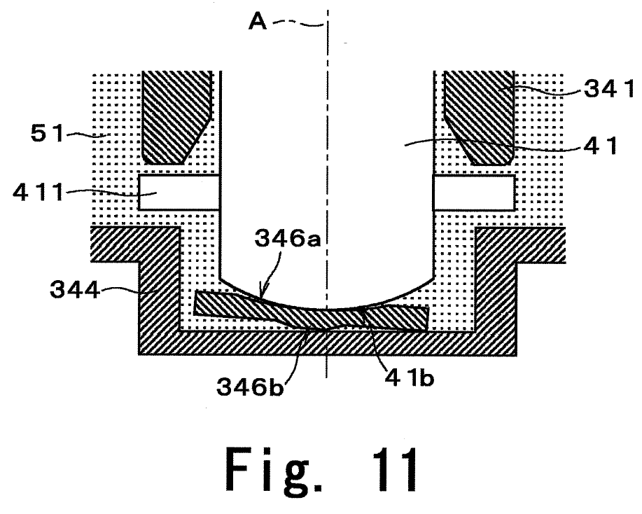

For example, the thrust plate may have shapes as shown in FIGS. 10 and 11. The thrust plate 346 shown in FIGS. 10 and 11 preferably includes a concave portion 346a of a concave curved shape in the center portion of the upper surface thereof. The thrust plate 346 preferably includes a plate convex portion 346b which protrudes toward the bottom portion of the bearing housing 344 in the center portion of the lower surface thereof. Accordingly, the thrust plate 346 can move in the radial direction, thereby performing the center alignment of the shaft 41 and the thrust plate 346. In addition, the thrust plate 346 is preferably inclined, so that the center alignment of the shaft 41 and the thrust plate 346 can be performed.

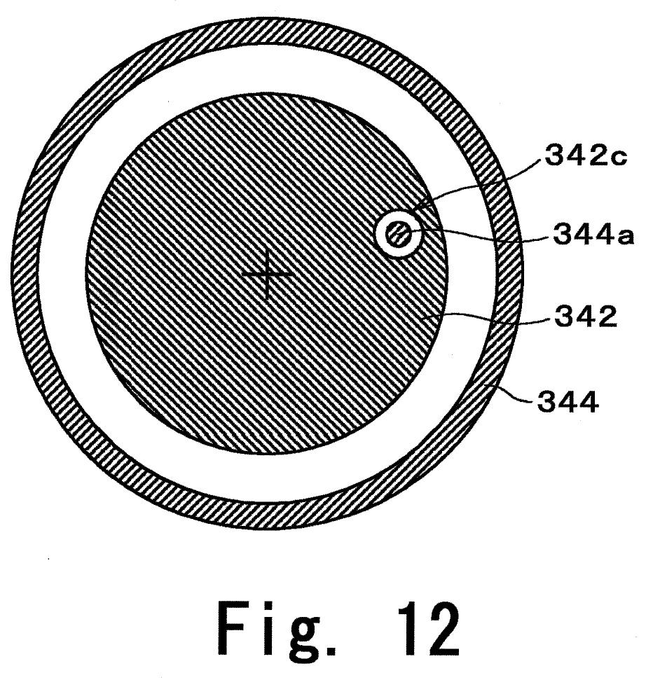

The mechanism for preventing the circumferential rotation of the thrust plate 342 is not limited to the mechanism as shown in FIG. 6, but may be the mechanisms as shown in FIGS. 12 to 14.

In FIG. 12, a housing protruding portion 344a formed on the bottom-portion upper surface of the bearing housing 344 is engaged with a through hole 342c formed in the thrust plate 342. The housing protruding portion 344a mutually comes into contact with an inner circumferential surface of the through hole 342c of the thrust plate 342in the circumferential direction, thereby minimizing the circumferential rotation of the thrust plate 342.

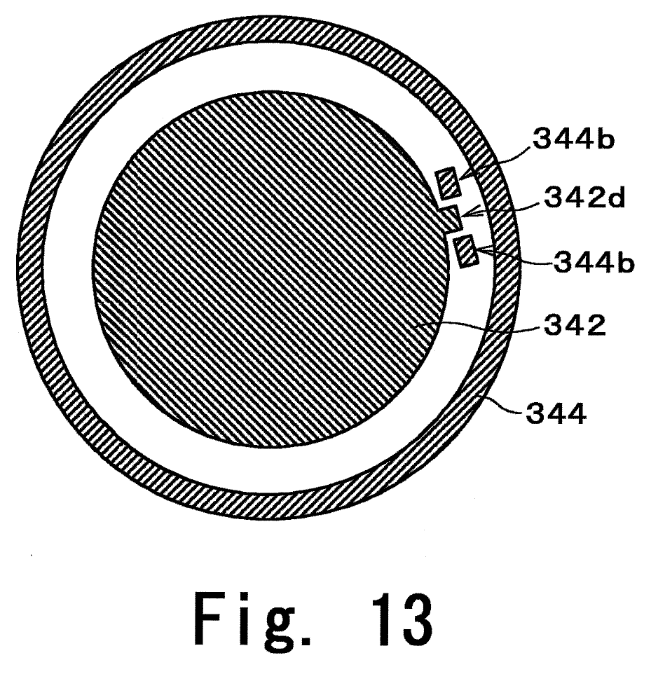

In FIG. 13, a housing protruding portion 342d formed in the peripheral portion of the thrust plate 342 toward the radial outside is preferably disposed between a pair of housing protruding portions 344b formed on the bottom-portion upper surface of the bearing housing 344. The housing protruding portions 344b and 342d become into contact with the thrust plate 342 in the circumferential direction, thereby minimizing the circumferential rotation of the thrust plate 342.

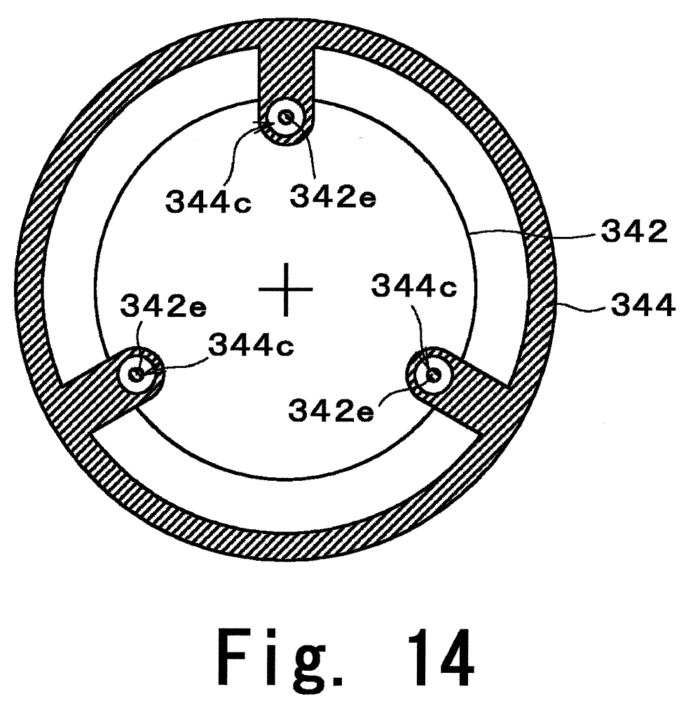

In FIG. 14, a plate protruding portion 342e formed in the thrust plate 342 is preferably engaged with a through hole 344c formed in the bearing housing 344. The plate protruding portion 342e becomes into contact with an inner circumferential surface of the through hole 344c of the bearing housing 344 in the circumferential direction, thereby preventing the circumferential rotation of the thrust plate 342. That is, it is sufficient that the thrust plate 342 may have an opposed face which is circumferentially opposed to a contact surface formed in the bearing housing 344. With such a configuration, the circumferential rotation of the thrust plate 342 can be minimized.

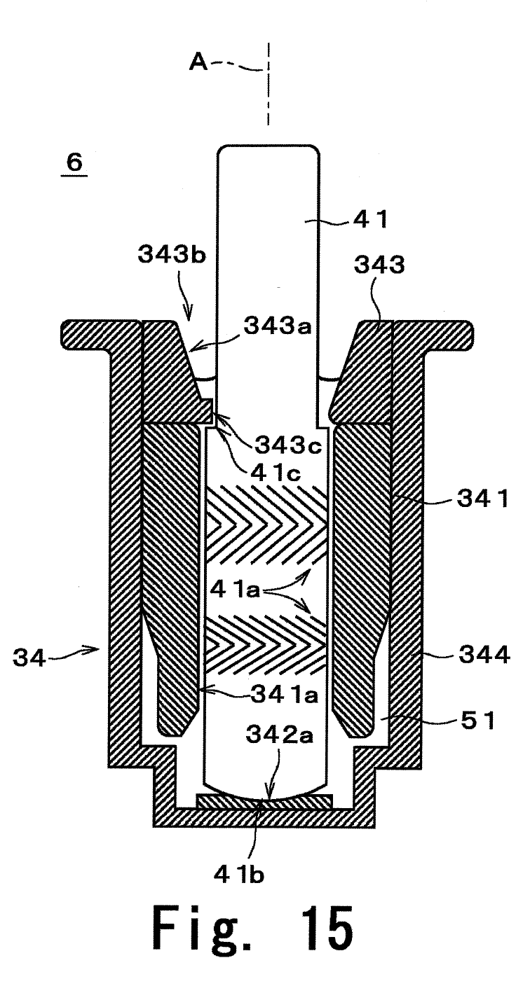

The fluid dynamic pressure bearing in the present invention may be a fluid dynamic pressure bearing as shown in FIG. 15. In the fluid dynamic pressure bearing 6 shown in FIG. 15, instead of the flange member 411, a seal convex portion 343c is preferably formed on the inner circumferential side of the seal member 343. By means of the seal convex portion 343c and a stepped portion 41c formed on the outer circumferential surface of the shaft 41, it is possible to prevent the shaft 41 from being slipped out of the bearing unit 34.

The outer periphery of the thrust plate is opposed to the inner circumferential surface of the bearing housing in the radial direction. However, the present invention is not limited to this configuration. For example, the thrust plate may be disposed in the bearing hole of the sleeve. In such a case, the outer periphery of the thrust plate is opposed to the inner circumferential surface of the sleeve in the radial direction.

In the above-described preferred embodiments, an outer rotor motor of shaft rotating type is described. However, the present invention is not limited to such a type of outer rotor motor. The spindle motor of the present invention may be a motor with a fixed shaft, or an inner rotor motor.

In the above-described preferred embodiments, the spindle motor 1 for rotating the magnetic data storage medium 22 is described. However, the spindle motor of the present invention may be a motor for rotating another type of recording disc such as an optical disc.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A fluid dynamic pressure bearing comprising:
a shaft having an end portion in which a convex curved face is formed;
a sleeve for supporting the shaft in a relatively rotatable manner with a center axis of the shaft as the center;
a lubricant retained between the shaft and the sleeve;
a thrust plate, disposed lower than the shaft, having a concave portion in which a concave curved face is formed, the concave curved face being in contact with the end portion of the shaft; and
a substantially cylindrical housing having a bottom in which the sleeve and the thrust plate are disposed, wherein
the thrust plate is immersed in the lubricant, and is in contact with the end portion of the shaft and an inner bottom face of the housing, respectively, thereby being axially held therebetween without being fixed to the housing.

2. A fluid dynamic pressure bearing according to claim 1, wherein a curvature radius of the concave curved face of the thrust plate is equal to or larger than a curvature radius of the convex curved face of the shaft.

3. A fluid dynamic pressure bearing according to claim 2, wherein a distance from the center axis to an outer peripheral portion of the concave portion in a direction substantially orthogonal to the center axis is larger than a gap between an outer circumferential surface of the thrust plate and an inner circumferential surface of the housing in the direction substantially orthogonal to the center axis.

4. A fluid dynamic pressure bearing according to claim 1, wherein a dimension of the thrust plate in the direction substantially orthogonal to the center axis is equal to or larger than a half of the dimension of an inner circumferential surface of the housing in the direction substantially orthogonal to the center axis.

5. A fluid dynamic pressure bearing according to claim 1, wherein the housing includes a housing protruding portion which protrudes upwards from the bottom portion, and
the thrust plate includes an opposed face which is opposed to the housing protruding portion in a circumferential direction with respect to the center axis.

6. A spindle motor comprising:
a base member;
a stator core and a coil fixed to the base member;
a rotor unit rotatably supported by the fluid dynamic pressure bearing of claim 1; and
a rotor magnet attached to the rotor unit in an opposed manner to the stator core and the coil.

7. A disk driver for rotating a disc, comprising:
a housing;
the spindle motor of claim 6, fixed to the interior of the housing, in which the disc is mounted on the rotor unit; and
an access portion for performing reading and/or writing of information from and to the disc.

8. A fluid dynamic pressure bearing comprising:
a shaft having an end portion in which a convex curved face is formed;
a sleeve for supporting the shaft in a relatively rotatable manner with a center axis of the shaft as the center;
a lubricant retained between the shaft and the sleeve;
a thrust plate which is disposed lower than the shaft, the thrust plate being in contact with the end portion of the shaft; and
a substantially cylindrical housing having a bottom in which the sleeve and the thrust plate are disposed, wherein
the thrust plate includes a plate convex portion of a curved shape which protrudes downwards from a lower surface of the thrust plate, the plate convex portion being in contact with an inner bottom face of the housing, and
the thrust plate is immersed in the lubricant, and is in contact with the end portion of the shaft and the inner bottom face of the housing, respectively, thereby being held therebetween without being fixed to the housing.

9. A fluid dynamic pressure bearing according to claim 8, wherein a curvature radius of the concave curved face of the thrust plate is equal to or larger than a curvature radius of the convex curved face of the shaft.

10. A fluid dynamic pressure bearing according to claim 9, wherein a distance from the center axis to an outer peripheral portion of the concave portion in a direction substantially orthogonal to the center axis is larger than a gap between an outer circumferential surface of the thrust plate and an inner circumferential surface of the housing in the direction substantially orthogonal to the center axis.

11. A fluid dynamic pressure bearing according to claim 8, wherein, the dimension of the thrust plate in a direction substantially orthogonal to the center axis is equal to or larger than a half of the dimension of the inner circumferential surface of the housing in the direction substantially orthogonal to the center axis.

12. A fluid dynamic pressure bearing according to claim 8, wherein
the housing includes a housing protruding portion which protrudes upwards from the bottom portion, and
the thrust plate includes an opposed face which is opposed to the housing protruding portion in a circumferential direction with respect to the center axis.

13. A spindle motor comprising:
a base member;
a stator and a coil fixed to the base member;
a rotor unit rotatably supported by the fluid dynamic pressure bearing of claim 9; and
a rotor magnet attached to the rotor unit in an opposed manner to the stator core and the coil.

14. A disk driver for rotating a disc, comprising:
a housing;
the spindle motor of claim 13 which is fixed to the interior of the housing, and in which the disc is mounted on the rotor unit; and
an access portion for performing reading and/or writing of information from and to the disc.

15. A production method of a fluid dynamic pressure bearing, comprising the steps of
a) disposing a shaft having an end portion in which a convex curved face is formed in an axially lower end portion, a substantially cylindrical sleeve through which the shaft is inserted, a thrust plate having a concave curved face which is in contact with the end portion of the shaft is formed on an upper surface thereof, and a substantially cylindrical housing having a bottom in which a lower portion is closed and an upper portion is opened;
b) accommodating the thrust plate, the sleeve, and the shaft in the housing, and disposing an outer circumferential surface of the shaft so as to be opposed to an inner circumferential surface of the sleeve, and the end portion of the shaft so as to be opposed to the concave curved face of the thrust plate;
c) filling a gap between the shaft and the thrust plate and a gap between the thrust plate and an inner bottom face of the housing with a lubricant; and
d) after the step (c), performing center alignment for determining relative positions of the center axis of the shaft and the concave curved face of the thrust plate by relatively rotating the sleeve and the shaft with an center axis of the shaft as the center in the condition where the end portion of the shaft is in contact with the concave curved face of the thrust plate.

16. A production method of a fluid dynamic pressure bearing according to claim 15, wherein by the step d), a position of a center of gravity of the thrust plate substantially agrees with the center axis of the shaft.

17. A production method of a fluid dynamic pressure bearing according to claim 15, wherein in the step d), in conjunction with the relative rotation, the thrust plate radially moves with respect to the end portion of the shaft, thereby performing the center alignment.

18. A production method of a fluid dynamic pressure bearing, comprising the steps of:
a) disposing a shaft having an end portion in which a convex curved face is formed in an axially lower end portion, a substantially cylindrical sleeve through which the shaft is inserted, a thrust plate having a plate convex portion of a curved shape which protrudes downwards, and a substantially cylindrical housing having a bottom in which a lower portion is closed and an upper portion is opened;
b) accommodating the thrust plate, the sleeve, and the shaft in the housing, and disposing an outer circumferential surface of the shaft so as to be opposed to an inner circumferential surface of the sleeve, and the end portion of the shaft so as to be opposed to an upper surface of the thrust plate;
c) filling a gap between the shaft and the thrust plate and a gap between the thrust plate and an inner bottom face of the housing with a lubricant; and
d) after the step c), performing center alignment for determining the relative position and orientation of the thrust plate with respect to the center axis of the shaft by relatively rotating the sleeve and the shaft with the center axis of the shaft as the center in the condition where the end portion of the shaft is in contact with the upper surface of the thrust plate.

19. A production method of a fluid dynamic pressure bearing according to claim 18, wherein in the step d), in conjunction with the relative rotation, the thrust plate is inclined in accordance with the position in which the thrust plate is in contact with the end portion of the shaft, thereby performing the center alignment.

20. A production method of a fluid dynamic pressure bearing according to claim 18, wherein the production method further comprises, before the step d), an assembling step of attaching a base member having a stator core and a coil to the housing, and attaching a rotor unit having a rotor magnet to the shaft, and
in the step d), a torque is generated between the stator core and the coil, and the rotor magnet, thereby rotating the shaft.
